(19) United States
(12) Patent Application Publication
(10) Pub. No.: US 2007/0092435 A1
(43) Pub. Date: Apr. 26, 2007

(54) METHOD FOR MANUFACTURING HYDROGEN

(75) Inventors: Kenji ESSAKI, Kawasaki-shi (JP); Masahiro Kato, Naka-gun (JP); Yukishige Maezawa, Hachioji-shi (JP); Takehiko Muramatsu, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/560,203

(22) Filed: Nov. 15, 2006

(30) Foreign Application Priority Data
Sep. 14, 2005 (JP) 2005-267071

(51) Int. Cl. C01B 3/02

(52) U.S. Cl. 423/648.1

(57) ABSTRACT

A method for manufacturing hydrogen includes supplying ethanol to a reactor which is filled with a reforming catalyst and a carbon dioxide absorbent containing a lithium composite oxide, and heating the reactor under the condition that the inside thereof is pressurized to 3 to 15 atm to carry out water-vapor reforming of the ethanol.

### CROSS REFERENCE TO RELATED APPLICATIONS

This is a Continuation Application of PCT Application No. PCT/JP2006/318460, filed Sep. 12, 2006, which was published under PCT Article 21 (2) in English.

This application is based upon and claims the benefit of priority from prior Japanese Patent Application No. 2005-267071, filed Sep. 14, 2005, the entire contents of which are incorporated herein by reference.

### BACKGROUND OF THE INVENTION

1. Field of the Invention

The present invention relates to a method for manufacturing hydrogen by utilizing water-vapor reforming of ethanol.

2. Description of the Related Art

A water-vapor reforming reaction in which ethanol is reacted with high-temperature vapor to produce hydrogen is carried out by the following formula (1).
C₂H₅OH+3H₂O [symbol] 6H₂+2CO₂ (1)

In the manufacturing of hydrogen, in fact, a large amount of byproducts such as methane, carbon monoxide, carbon dioxide or the like are generated in addition to hydrogen as a main product. Consequently, hydrogen yield, i.e., the amount of hydrogen obtained from 1 mol of ethanol does not reach 6 mol. In order to remove the byproducts, gas purification is required after the water-vapor reforming reaction. Furthermore, the degradation of a catalyst mainly due to carbon deposit onto the catalyst proceeds, and the performance thereof is reduced over time (see F. Frusteri et al, Journal of Power Sources, 132, 139 [2004 ]).

JP-A 10-152302 (KOKAI) and JP-A 2002-274809 (KOKAI) disclose methods for using an inorganic carbon dioxide absorbent containing a lithium composite oxide in addition to a conventional solid catalyst in a reaction in which carbon dioxide is generated as a byproduct, such as a reforming reaction. Since the carbon dioxide can be removed from a high temperature reaction field exceeding 400° C., the chemical equilibrium of the formula (1) can be shifted to the generation side of the main product by the method to efficiently obtain hydrogen. Due to lithium silicate in the lithium composite oxides has a particularly large carbon dioxide absorption rate, the lithium silicate is a material suitable for the shift of the chemical equilibrium, and the shift effect of the equilibrium to the water-vapor reforming of methane is confirmed and shown by an experiment (see M. Kato et al, Journal of Ceramics Society of Japan, 113 [3 ], 252 [2005]). The reaction of the carbon dioxide absorption by the lithium silicate is shown by the following formula (2).
Li₄SiO₄+CO₂ [symbol] Li₂CO₃+Li₂SiO₃ (2)

When a rightward reaction is caused in the formula (2), the carbon dioxide is reacted with the lithium silicate, and is absorbed.

The hydrogen yield is increased by making the carbon dioxide absorbent to exist in the reaction field of the water-vapor reforming of the ethanol and carrying out the shift of the equilibrium. The concentration of impurities such as methane, carbon monoxide and carbon dioxide is simultaneously reduced. Accordingly, it is shown by calculation that the energy conversion efficiency is increased, and the hydrogen concentration after moisture removal reaches at up to 96% (see J. Comas et al, Journal of Power Sources, 138, 61 [2004]). In such a case, it also results an effect, in which a gas purification process carried out after the reaction of the water-vapor reforming can be usually simplified. It is shown that the hydrogen concentration after moisture removal rises from the order of 57% to the order of 75% in an experiment in which the lithium silicate is actually used for the water-vapor reforming of the ethanol (see Y. Iwasaki et al, Proceedings of the 10th APCChE Congress, Kitakyushu, Japan, 2004, and CD-ROM).

However, in the method, the hydrogen yield is less than 3 mol, and the impurities of 25% are contained. In order to reduce the difference between the results due to the calculation and the data due to the actual reaction, methods for further increasing the effect due to the shift of the equilibrium to improve the hydrogen yield and reduce the impurities have been required.

### BRIEF SUMMARY OF THE INVENTION

According to the invention, there is provided a method for manufacturing hydrogen, which comprising:

supplying ethanol to a reactor which is filled with a reforming catalyst and a carbon dioxide absorbent containing a lithium composite oxide; and

heating the reactor under the condition that the inside thereof is pressurized to 3 to 15 atm, thereby carrying out water-vapor reforming of the ethanol.

### BRIEF DESCRIPTION OF THE SEVERAL VIEWS OF THE DRAWING

FIG. 1 is a partial sectional view showing a reforming reaction apparatus used for method according to an embodiment.

FIG. 2 shows a hydrogen manufacturing apparatus according to an another embodiment, and is a flow diagram showing a state where the water-vapor reforming of ethanol is being carried out in a first reforming reactor and the regeneration is being carried out in a second reforming reactor.

FIG. 3 shows the same hydrogen manufacturing apparatus as that of FIG. 2, and is a flow diagram showing a state where the regeneration is being carried out in the first reforming reactor and the water-vapor reforming of ethanol is being carried out in the second reforming reactor.

### DETAILED DESCRIPTION OF THE INVENTION

Hereinafter, a method for manufacturing hydrogen according to an embodiment of the present invention will be described in detail with reference to the drawings.

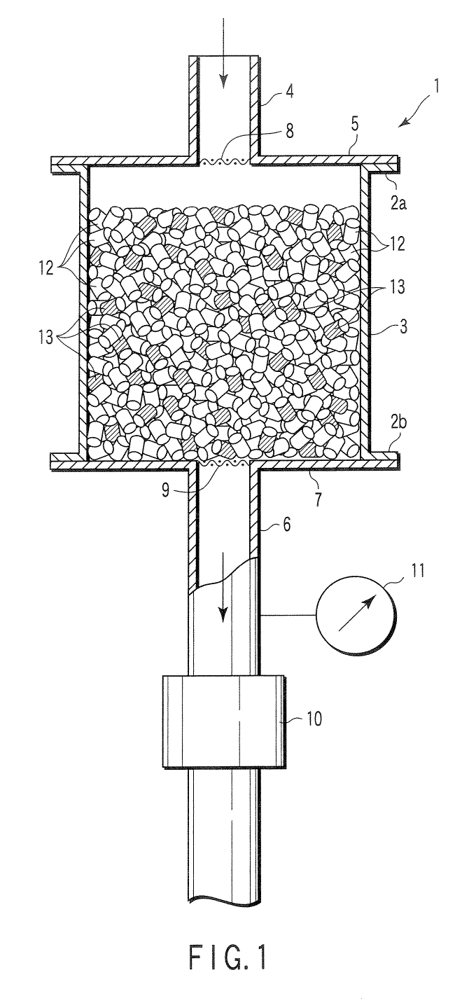

FIG. 1 is a sectional view showing a reforming reaction apparatus used for method according to an embodiment. A reforming reactor 1 comprises a cylindrical body 3 having flanges 2a, 2b at its both ends. An upper disk-like lid body 5 is in contact with the flange 2a as one end (upper end) of the main body 3 and has a gas introducing pipe 4. A lower disk-like lid body 7 is in contact with the flange 2b as the other end (lower end) of the main body 3 and has a product gas discharge pipe 6. The flanges 2a, 2b of the cylindrical body 3 have a plurality of opened bolt through-holes (not shown) respectively, and each of the disk-like lid bodies 5, 7 has also opened bolt through-holes (not shown) corresponding to these through-holes. The disk-like lid bodies 5, 7 are fixed to the cylindrical body 3 by respectively inserting bolts into the matched bolt through-holes of the flange 2a of the upper end of the cylindrical body 3 and upper disk-like lid body 5 and the matched bolt through-holes of the flange 2b of the lower end of the cylindrical body 3 and lower disk-like lid body 7 and tightening the bolts using nuts.

Meshes 8, 9 are respectively attached to an opening part of the gas introducing pipe 4 of the upper disk-like lid body 5 and an opening part of the product gas discharge pipe 6 of the lower disk-like lid body 7. The product gas discharge pipe 6 is equipped with a back pressure valve 10 and a pressure gauge 11. The cylindrical body 3 of the reforming reactor 1 is filled with a reforming catalyst 12 and a carbon dioxide absorbent 13 containing a lithium composite oxide in a mixed state.

For example, a heating member (not shown) for flowing combustion gas heated to a predetermined temperature is provided on the outer peripheral surfaces of a portion of the gas introducing pipe 4 including the cylindrical body 3 and of a portion of the product gas discharge pipe 6.

The method for manufacturing hydrogen according to the embodiment will be described using the reforming reaction apparatus shown in FIG. 1.

The ethanol (for example, an ethanol water solution) is previously vaporized, and the vapor of the ethanol water solution is in contact with the reforming catalyst 12 and the carbon dioxide absorbent 13 containing lithium composite oxide (for example, lithium silicate) filled in the cylindrical body 3 while the vapor is flown through the gas introducing pipe 4. During the above operation, the pressure inside the cylindrical body 3 is controlled to 3 to 15 atm by adjusting the restriction of the back pressure valve 10. The inside of the main body 3 is simultaneously heated to a desired temperature by passing the combustion gas into the heating member (not shown). A water-vapor reforming reaction of the ethanol is carried out under the presence of the reforming catalyst 12 according to the above formula (1) by the introduction of the vapor of the ethanol water solution into the cylindrical body 3 and the regulation and heating of the internal pressure of the cylindrical body 3 to produce hydrogen and carbon dioxide. The carbon dioxide is simultaneously reacted with the carbon dioxide absorbent (for example, lithium silicate) 13 coexisting with the reforming catalyst 12 according to the above formula (2), absorbed and removed. As a result, the reaction of the above formula (1) is promoted. The manufactured hydrogen is recovered through the product gas discharge pipe 6.

A reforming catalyst has, for example, a structure where catalyst metal fine particles are supported on a carrier. Examples of the carriers are alumina, magnesia, ceria, lanthanum oxide, zirconia, silica and titania. Examples of the catalyst metals are nickel, ruthenium, rhodium, palladium, platinum and cobalt. This catalyst metal can be used singly or mixture. Nickel and rhodium are particularly preferable.

Examples of the carbon dioxide absorbents are a lithium composite oxide alone, or a mixture of a lithium composite oxide and alkali compound such as an alkali carbonate or an alkali oxide. Examples of the alkali carbonate are potassium carbonate and sodium carbonate. Examples of the lithium composite oxides are lithium silicate and lithium zirconia. Lithium silicate is particularly preferable. The lithium silicate represented, for example, by LiₓSᵢyO_{z} (where x+4y−2z=0) can be used. Examples of the lithium silicates represented by the formula are lithium orthosilicate (Li₄SiO₄), lithium metasilicate (Li₂SiO₃), Li₆Si₂O₇ and Li₈SiO₆. The lithium orthosilicate is particularly preferable since the temperature for the absorption and desorption of the carbon dioxide in the lithium orthosilicate is high and the carbon dioxide can be separated at a higher temperature. In fact, these lithium silicates may have a somewhat different composition from the stoichiometry ratio represented by the chemical formula.

Although the mixture ratio of the reforming catalyst and carbon dioxide absorbent is based on the kind and shape of each of the materials, it is preferable to set the mixture ratio 1:1 to 1:8 by weight ratio.

It is preferable that the reforming catalyst and the carbon dioxide absorbent have a granular or pellet shape. Furthermore, it is desirable that the reforming catalyst and the carbon dioxide absorbent have a size (particularly, diameter) of 2 to 10 mm. When the size is set to less than 2 mm, the pressure loss due to the flow of the vapor of the ethanol water solution may be increased to reduce the production efficiency of the hydrogen. On the other hand, if the size exceeds 10 mm, particularly, the diffusion of various gases in the carbon dioxide absorbent reaches a rate-determining, and thereby it is difficult to complete the reaction.

It is preferable that the carbon dioxide absorbent is a porous body composed of primary particles of 2 to 50 μm and having a porosity of 30 to 80%. The carbon dioxide absorbent composed of the porous body exhibits high reactivity with the carbon dioxide.

If the pressure inside the cylindrical body is set to less than 3 atm, an effect due to the shift of equilibrium cannot be fully attained. On the other hand, if the pressure exceeds 15 atm, the effect due to the shift of the equilibrium is reduced. That is, since the water-vapor reforming reaction of the ethanol of the formula (1) described above increases the number of moles of gas, the reaction hardly proceeds with the rising of the pressure inside the reactor. On the other hand, the partial pressure of the carbon dioxide is increased with the rising of the pressure inside the reactor, thereby promoting the absorption reaction of the carbon dioxide with the carbon dioxide absorbent. Therefore, since the influence of the equilibrium applied to the shift due to the pressurization of the inside of the reactor depends on the characteristics of the water-vapor reforming reaction and absorbing reaction of the carbon dioxide with the carbon dioxide absorbent, the water-vapor reforming reaction and the absorbing reaction of the carbon dioxide by the carbon dioxide absorbent can be promoted in a well-balanced manner by setting the pressure inside the reactor to 3 to 15 atm. It is more preferable that the pressure inside the reactor is 3 to 10 atm.

Although the optimal value of the temperature during the water-vapor reforming in the reactor varies depending on pressure, it is preferable to set the temperature to 600 to 750° C. It is particularly preferable that the temperature is lowered at the low pressure side and increased at the high pressure side in the range of 3 to 15 atm.

When the carbon dioxide absorbent absorbs the carbon dioxide and the absorption performance of the carbon dioxide absorbent is reduced in the water-vapor reforming reaction, the carbon dioxide can be regenerated. That is, the reaction of the carbon dioxide absorbent (for example, lithium silicate) and carbon dioxide is a reversible reaction shown by the above formula (2). Therefore, the carbon dioxide can be desorbed by heating the lithium silicate having absorbed the carbon dioxide at a temperature higher than the temperature during the absorption, thereby regenerating the carbon dioxide.

Thus, since the carbon dioxide absorbent containing the lithium composite oxide (for example, lithium silicate) can absorb and desorb the carbon dioxide, the water-vapor reforming can be carried out in at least one reactor of a plurality of reactors previously prepared, and the carbon dioxide can be simultaneously desorbed from the carbon dioxide absorbent having been absorbed the carbon dioxide in the remaining reactors to almost continuously produce the hydrogen.

The carbon dioxide desorbed from the carbon dioxide absorbent can be recovered as the carbon dioxide of high purity by regenerating the carbon dioxide absorbent under a carbon dioxide atmosphere. It is preferable to carry out the regeneration at 900° C. or less at the atmospheric pressure. When the temperature during the regeneration exceeds 900° C., the carbon dioxide absorbent (for example, lithium silicate) may be intensively deteriorated. On the other hand, although the recovery and use of the carbon dioxide are limited when the carbon dioxide absorbent is regenerated under an atmosphere which is free from the carbon dioxide, such as nitrogen and air, the regeneration can be carried out at a comparatively low temperature of 550 to 700° C. at the atmospheric pressure.

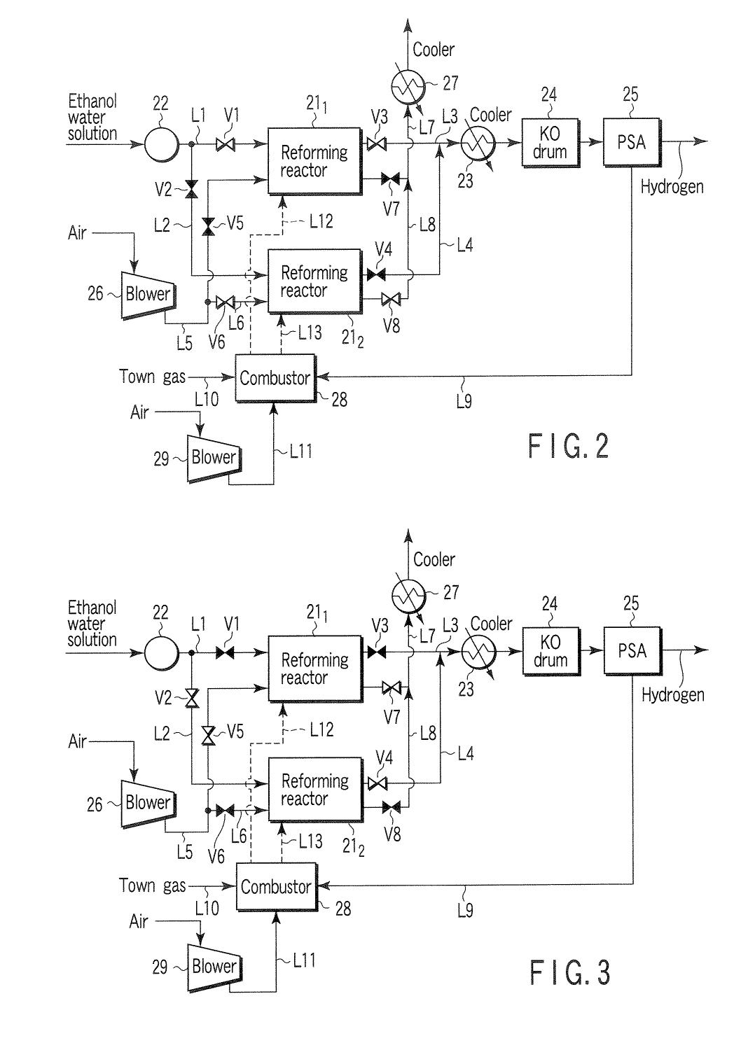

Next, with reference to flow diagrams of hydrogen manufacturing apparatuses shown in FIGS. 2, 3, a hydrogen production method using ethanol will be specifically described. Each of FIGS. 2, 3 shows the same hydrogen manufacturing apparatus, and the water-vapor reforming reaction by means of two reforming reactors and the regeneration of the carbon dioxide absorbent are reversed.

A first and second reforming reactors 21₁, 21₂ are respectively filled with the reforming catalyst having a pellet shape and the carbon dioxide absorbent consisting of, for example, lithium silicate in a mixed state. A heating tube (not shown) to which combustion gas of a combustor to be described later is supplied is wound around the outer peripheral surfaces of the reforming reactors 21₁, 21₂. A first ethanol supply line L1 is connected to the first reforming reactor 21₁, and an evaporator 22 and a control valve V1 are interposed from upstream toward downstream. A second ethanol supply line L2 is branched from a portion of the first supply line L1 located between the evaporator 22 and the control valve V1, and is connected to the second reforming reactor 21₂. A control valve V2 is interposed in the second ethanol supply line L2.

A first produced hydrogen discharge line L3 is extended from the first reforming reactor 21₁. A pressure gauge (not shown), a back pressure valve V3, a first cooler 23, a gas-liquid separator (KO drum) 24, and a pressure swing adsorption (PSA) 25 are interposed from upstream toward downstream in the first produced hydrogen discharge line L3. A second produced hydrogen discharge line L4 has one end connected to the second reforming reactor 21₂ and the other end connected to a portion of the first discharge line L3 located between the back pressure valve V3 and the first cooler 23. A pressure gauge (not shown) and a back pressure valve V4 are interposed from upstream toward downstream in the second produced hydrogen discharge line L4.

A first air supply line L5 is connected to the first reforming reactor 21₁. A first blower 26 and a control valve V5 are interposed from upstream toward downstream in the first air supply line L5. A second air supply line L6, which is branched from a portion of the supply line L5 located between the first blower 26 and the control valve V5, is connected to the second reforming reactor 21₂. A control valve V6 is interposed in the second air supply line L6.

A first carbon dioxide exhaust line L7 is extended from the first reforming reactor 21₁. A control valve V7 and a second cooler 27 are interposed from upstream toward downstream in the first carbon dioxide exhaust line L7. A second carbon dioxide exhaust line L8 has one end connected to the second reforming reactor 21₂ and the other end connected to a portion of the first exhaust line L7 located between the control valve V7 and the second cooler 27. A control valve V8 is interposed in the second carbon dioxide exhaust line L8.

An off-gas return line L9 has one end connected to the PSA 25 and the other end connected to a combustor 28. A supply line L10 of fuel, for example, town gas, is connected to the combustor 28. An air supply line L11 is connected to the combustor 28. A second blower 29 is interposed in the air supply line L11. Hot combustion gas generated in the combustor 28 is supplied to heating tubes (not shown) of the first and second reforming reactors 211, 212 through a first and second heat supply lines L12, L13.

Next, the method for manufacturing hydrogen using the hydrogen manufacturing apparatuses shown in FIGS. 2, 3 described above and the reproduction method for the carbon dioxide absorbent will be described.

First, the control valve V2, the back pressure valve V4 and the control valves V5, V7 respectively interposed in the second ethanol supply line L2, from second produced hydrogen discharge line L4, the first air supply line L5 and the first carbon dioxide exhaust line L7 are closed. The restriction of the back pressure valve V3 is adjusted while the control valves V1, V6, V8 other than these valves are opened. The control valve and back pressure valve which are closed in FIG. 2 are painted out in black, and the opened control valve and the back pressure valve of which the restriction is adjusted are shown as white space.

The town gas, and off-gas to be described later are supplied to the combustor 28 through the supply line L10 and the off-gas return line L9, respectively. The town gas and the off-gas are mixed with air supplied from the air supply line L11 in which the second blower 29 is interposed, and burned. Heat obtained in the combustor 28 is supplied to the heating tubes of the first and second reforming reactors 21₁, 21₂ through the heat supply lines L12, 13 to heat the first and second reforming reactors 21₁, 21₂ to a desired temperature.

After the opening/closing and restriction adjustment of the valves, and heating due to the heat supply from the combustor 28 to the first and second reforming reactors 21₁, 21₂, the ethanol water solution is supplied to the first ethanol supply line L1. The ethanol water solution is then vaporized in the evaporator 22, and the vapor is supplied to the first reforming reactor 21₁. The inside of the first reforming reactor 21₁ is pressurized to 3 to 15 atm by the restriction adjustment of the back pressure valve V3. The generation of the hydrogen due to the water-vapor reforming of the ethanol, and the reaction absorption and removal of the carbon dioxide produced as a by-product due to the lithium silicate are carried out according to the above formulae (1), (2) by the heating at, for example, 600 to 750° C. due to the heat supply of the combustor 28 under a coexistence of the reforming catalyst and carbon dioxide absorbent consisting of the lithium silicate. After the hydrogen gas of high purity produced in the first reforming reactor 21₁ is cooled in the first cooler 23, moisture is removed in the KO drum 24. Finally, impurities are removed in the PSA 25 to recover the hydrogen gas as product hydrogen. The off-gas recovered in the PSA 25 is supplied to the combustor 28 through the off-gas return line L9 as fuel.

While air is simultaneously supplied to the second reforming reactor 21₂ from the first air supply line L5 in which the first blower 26 is interposed and the second air supply line L6, the lithium silicate (carbon dioxide absorbent) with which the second reforming reactor 21₂ is filled and has already absorbed the carbon dioxide is regenerated by the heating at, for example, 550 to 700° C. due to the heat supply from the combustor 28. The carbon dioxide-containing gas generated in the second reforming reactor 21₂ is supplied to the second cooler 27 through the second carbon dioxide exhaust line L7 and the first carbon dioxide exhaust line L7, and is discharged after being cooled in the second cooler 27.

When the absorption of the carbon dioxide by the lithium silicate (carbon dioxide absorbent) fully proceeds in the first reforming reactor 21₁ in which the water-vapor reforming of the ethanol is carried out, and the carbon dioxide absorption leads to the breakthrough, as shown in FIG. 3, the first reforming reactor 21₁ is switched to the regeneration process, and the second reforming reactor 21₂ in which the regeneration is ended is switched to the reforming process. That is, the control valves V2, V4, V5 interposed in the second ethanol supply line L2, the first air supply line L5 and the first carbon dioxide exhaust line L7, respectively, are opened, and the restriction of the back pressure valve V4 of the second produced hydrogen discharge line L4 is adjusted. The control valves V1, V6, V8 and the back pressure valve V3 other than these valves are closed. The control valves and back pressure valves which were closed in FIG. 3 are painted out in black, and the opened control valves and back pressure valves of which the restriction is adjusted are exhibited as white space.

The ethanol water solution is supplied to the first ethanol supply line L1 after the opening/closing and restriction adjustment of the valves under a condition where the first and second reforming reactors 21₁, 21₂ are heated by heat supplied from the combustor 28. The ethanol water solution is vaporized in the evaporator 22, and hydrogen gas of high purity is produced by supplying the vapor to the second reforming reactor 21₂ pressurized to 3 to 15 atm by the restriction adjustment of the back pressure valve V4 through the ethanol supply line L2. After the produced hydrogen gas of high purity is supplied to the first cooler 23 through the second produced hydrogen discharge line L4 and the first produced hydrogen discharge line L3 and is cooled herein, moisture is removed in the KO drum 24. Finally, impurities are removed in the PSA 25 to recover the hydrogen gas as product hydrogen. The off-gas recovered in the PSA 25 is supplied to the combustor 28 through the off-gas return line L9 as fuel.

While the air is simultaneously supplied to the first reforming reactor 21₁ from the first air supply line L5 in which the first blower 26 interposed, the lithium silicate (carbon dioxide absorbent) with which the first reforming reactor 21_{1 is filled and has already absorbed the carbon dioxide is reproduced by the heating at, for example,} 550 to 700° C. by means of the heat supply from the combustor 28. The carbon dioxide-containing gas generated in the first reforming reactor 21₁ is supplied to the second cooler 27 through the first carbon dioxide exhaust line L7, and is discharged after being cooled in the second cooler 27.

Thus, in the first and second reforming reactors 21₁, 21₂, the hydrogen can be continuously produced from the ethanol water solution by alternately switching the water-vapor reforming and the reproduction.

As described above, according to the embodiment, when carrying out the water-vapor reforming of the ethanol in the reactor filled with the reforming catalyst and the carbon dioxide absorbent, the water-vapor reforming reaction and the absorbing reaction of the carbon dioxide by the carbon dioxide absorbent can be promoted in a well-balanced manner by setting the pressure inside the reactor to 3 to 15 atm.

Consequently, the method for manufacturing hydrogen using the ethanol can be provided, which attains the improvement in production yield of the hydrogen and the reduction in impurities.

The water-vapor reforming is carried out in at least one reactor of the prepared plurality of reactors, and the carbon dioxide is simultaneously desorbed from the carbon dioxide absorbent which has absorbed carbon dioxide in the remaining reactors to regenerate the carbon dioxide. Thereby, the improvement in production yield of the hydrogen and the reduction in impurities can be attained, and the hydrogen can be continuously produced.

Hereinafter, Examples of the present invention will be described in detail with reference to the above reforming reaction device of FIG. 1.

### EXAMLPE 1

The cylindrical body 3 (inner diameter: 0.02 m, height: 1.2 m) of the above reforming reactor 1 shown in FIG. 1 was filled with 40g of the reforming catalyst and 240 g of the carbon dioxide absorbent in a mixed state so that the height thereof was set to 1.0 m. As the reforming catalyst, there were used alumina particles as carriers on which rhodium of 5% by weight was supported and which had an average particle diameter of about 5 mm. As the carbon dioxide absorbent, there was used a powder compact, i.e., a porous body having a diameter of 5 mm, a length of 5 mm and a porosity of 50%, which was obtained by pressurizing and molding lithium silicate powder having a particle diameter of 2 to 4 μ m.

The vapor of the ethanol water solution having a composition in which ethanol and water were mixed at the molar ratio of 1:6 was supplied in the amount of 0.033 m³/hr (gaseous normal condition conversion) to the cylindrical body 3 of the reforming reactor 1 heated to 600° C. through the gas introducing pipe 4, thereby carrying out the water-vapor reforming of the ethanol. At this time, the inside of the cylindrical body 3 was pressurized to 3 atm by the restriction adjustment of the back pressure valve 10 interposed in the product gas discharge pipe 6.

### EXAMPLE 2

The water-vapor reforming of the ethanol was carried out in the same manner as in Example 1 except that the temperature of the reforming reactor was set to 700° C. and the internal pressure thereof was set to 10 atm.

### EXAMPLE 3

The water-vapor reforming of the ethanol was carried out in the same manner as in Example 1 except that the temperature of the reforming reactor was set to 700° C. and the internal pressure thereof was set to 15 atm.

### COMPARATIVE EXAMPLE 1

The water-vapor reforming of the ethanol was carried out in the same manner as in Example 1 except that the internal pressure of the reforming reactor was set to 2 atm.

COMPARATIVE EXAMPLE 2

The water-vapor reforming of the ethanol was carried out in the same manner as in Example 1 except that the temperature of the reforming reactor was set to 700° C. and the internal pressure thereof was set to 20 atm.

In Examples 1 to 3 and Comparative Examples 1, 2, after 30 minutes from the flowing start of the vapor of the ethanol water solution into the cylindrical body of the reforming reactor, the composition of the gas exhausted from the product gas discharge pipe 6 was analyzed by a gas chromatography (GL Sciences Inc.; Micro GC [Name Model; CP4900]). The results are shown in the following Table 1.

TABLE 1

| | | | | Gas composition | | | |
|---|---|---|---|---|---|---|---|
| | Reforming reactor | | | (% by volume) | | | |
| | Temperature | Pressure | | H₂ | CH₄ | CO | CO₂ |
| Example 1 | 600° C. | 3 | atm | 97 | Remainder | 0.15 | 0.13 |
| Example 2 | 700° C. | 10 | atm | 97 | Remainder | 0.005 | 0.005 |
| Example 3 | 700° C. | 15 | atm | 95 | Remainder | 0.03 | 0.03 |
| Comparative | 600° C. | 2 | atm | 92 | Remainder | 0.8 | 0.7 |
| example 1 | | | | | | | |
| Comparative | 700° C. | 20 | atm | 86 | Remainder | 0.01 | 0.01 |
| example 2 | | | | | | | |

As is apparent from the above Table 1, it can be seen that Examples 1 to 3 exhibit a high hydrogen concentration, i.e., the hydrogen concentration exceeding 95% by volume in the generation gas obtained by the water-vapor reforming of the ethanol, and the carbon monoxide concentration of a low value, i.e., less than 0.5% by volume (0.15% by volume), thereby efficiently manufacturing the hydrogen. The carbon monoxide generated after the reforming is usually reduced to the order of 0.5% by the shift reaction in the methane reforming. While the hydrogen concentration can be raised by using the methods of Examples 1 to 3, the carbon monoxide concentration becomes a low value, i.e., less than 0.5% by volume (0.15% by volume) in the obtained high concentration hydrogen-containing gas. Consequently, the shift reaction can be omitted, and the carbon monoxide concentration can be easily reduced to 0.001% by volume or less by directly connecting the reforming reactor to a methanation reactor, a selective oxidation reactor, or a PSA gas purification device. As a result, when the obtained high concentration hydrogen-containing gas in which the carbon monoxide concentration is reduced is applied as fuel of a fuel cell, the catalyst of a fuel electrode can be prevented from being poisoned by the carbon monoxide.

On the other hand, it can be seen that in Comparative Example 1, the carbon monoxide concentration is high, and a large amount of methane which is the byproduct also remains, and the manufacturing efficiency of the hydrogen is low (hydrogen concentration: 92% by volume). This is believed to be based on the small shift effect of the equilibrium due to the carbon dioxide absorbent. Particularly, the inclusion of a large amount of methane which is hardly separated from the hydrogen becomes a factor which increases the amount of loss of hydrogen when the obtained generation gas is further purified.

It can be seen that although the carbon monoxide concentration of Comparative Example 2 becomes low, more methane byproduct remains as compared to Comparative Example 1, thereby remarkably reducing the manufacturing efficiency of the hydrogen, the hydrogen concentration being 86% by volume. The hydrogen concentration was reduced. This is believed to be based on the reaction which is insufficiently promoted even if the shift effect of the equilibrium is applied since the pressure inside the reforming reactor is increased to 20 atm and becomes a disadvantageous pressure condition for the ethanol reforming.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for manufacturing hydrogen, which comprising:
supplying ethanol to a reactor which is filled with a reforming catalyst and a carbon dioxide absorbent containing a lithium composite oxide; and
heating the reactor under the condition that the inside thereof is pressurized to 3 to 15 atm, thereby carrying out water-vapor reforming of the ethanol.

2. The method according to claim 1, wherein the reforming catalyst has a structure where a catalyst metal particle of at least one selected from the group consisting of nickel, ruthenium, rhodium, palladium, platinum and cobalt is supported on a carrier selected from alumina, magnesia, ceria, lanthanum oxide, zirconia, silica and titania.

3. The method according to claim 1, wherein the reforming catalyst has a granular or pellet shape and has a diameter of 2 to 10 mm.

4. The method according to claim 1, wherein the lithium composite oxide is lithium silicate.

5. The method according to claim 1, wherein the carbon dioxide absorbent is a porous body having particles of 2 to 50 μ m and a porosity of 30 to 80%.

6. The method according to claim 1, wherein the reactor is filled with the reforming catalyst and the carbon dioxide absorbent in a weight ratio of 1:1 to 1:8.

7. The method according to claim 1, wherein the ethanol supplied to the reactor is an ethanol water solution vapor.

8. The method according to claim 1, wherein the heating during the water-vapor reforming is carried out at a temperature of 600 to 750° C.

9. The method according to claim 1, wherein the reactor has an exhaust pipe having a back pressure valve interposed therein, and the inside of the reactor is pressurized to 3 to 15 atm by a restrictive operation of the back pressure valve.

10. The method according to claim 1, wherein the pressure inside the reactor during the water-vapor reforming is 3 to 10 atm.

11. The method according to claim 1, further comprising preparing a plurality of reactors, wherein the water-vapor reforming is carried out in at least one reactor, and carbon dioxide is simultaneously desorbed from the carbon dioxide absorbent having been absorbed the carbon dioxide in the remaining reactors to regenerate the carbon dioxide.
